(19) United States
(12) Patent Application Publication
(10) Pub. No.: US 2025/0156704 A1
(43) Pub. Date: May 15, 2025

(54) SECONDARY RECOMMENDATION METHOD BASED ON SERVICE COMPLEMENTARY RELATION LEARNING MODEL FOR RESTFUL SERVICE

(71) Applicants: China Jiliang University, Zhejiang (CN); Zhejiang Zhejiang Tourism Investment Digital Technology Co., Ltd, Zhejiang (CN); Zhejiang Tourism Investment Group Co., Ltd, Zhejiang (CN)

(72) Inventors: Jiawei Lu, Zhejiang (CN); Gang Xiao, Zhejiang (CN); Yun CAI, Zhejiang (CN); Xiaoye ZHANG, Zhejiang (CN); Liangzhong XU, Zhejiang (CN); Jiahong Zheng, Zhejiang (CN); Qibing Wang, Zhejiang (CN); Ge SHI, Zhejiang (CN); Duanni Li, Zhejiang (CN)

(73) Assignees: China Jiliang University, Zhejiang (CN); Zhejiang Zhejiang Tourism Investment Digital Technology Co., Ltd, Zhejiang (CN); Zhejiang Tourism Investment Group Co., Ltd, Zhejiang (CN)

(21) Appl. No.: 18/635,011

(22) Filed: Apr. 15, 2024

(30) Foreign Application Priority Data
Nov. 13, 2023 (CN) 202311504042.4

(51) Int. Cl. G06N 3/08

(52) U.S. Cl. CPC G06N 3/08

(57) ABSTRACT

Disclosed is a secondary recommendation method based on a service complementary relation learning model for a RESTful service. The method includes: firstly, establishing a service complementary relation learning model, and setting a service complementary relation rule; on the basis, extracting an initial service complementary relation, expanding the initial service complementary relation with service function similarity information, and creating a complementary relation graph structure; secondly, conducting representation learning on the complementary relation graph structure in combination with a mask graph attention mechanism, and obtaining embedded vectors of a RESTful service and a service function; then, computing a distance between the embedded vectors, and reducing the distance between the embedded vectors having a complementary relation with a hinge loss function; and finally, finding the RESTful service having the complementary relation according to user input, and conducting secondary service recommendation.

### CROSS-REFERENCE TO RELATED APPLICATION

This application claims the priority benefit of China application serial no. 202311504042.4, filed on Nov. 13, 2023. The entirety of the above-mentioned patent application is hereby incorporated by reference herein and made a part of this specification.

### TECHNICAL FIELD

The present disclosure relates to a secondary recommendation method based on a service complementary relation learning model for a RESTful service.

### BACKGROUND

As the Software-as-a-Service (SaaS) mode improves, more and more enterprises and organizations package business, data and resources as services, and publish them on the Internet in the form of a Web application programming interface (API). The number of Web services is multiplying. As a lightweight Web service type, a RESTful service has been widely used in the Internet because of its resource orientation, clear structure and strong expansibility. For instance, domestic cloud service enterprises, such as Aliyun, Tencent Cloud, and Ctyun, all use RESTful services as a main form so as to provide data and computing resources for users.

The increasing number of RESTful services and continuous emergence of functionally similar RESTful services make it difficult to find and choose a high-quality service. In this case, a service recommendation technology has received great attention.

Existing service recommendation technologies mainly include a collaborative filtering based service recommendation technology, a topic model based service recommendation technology, and a service quality based service recommendation technology.

The collaborative filtering based service recommendation technology mainly recommends functionally similar services to users through information such as user similarity and service similarity. For instance, the patent No. 201710211954.0 is a collaborative filtering method for Web service recommendation. It filters Web services with information of service credibility and user preference and recommends a service to a user.

The topic model based service recommendation technology can excavate a potential topic relation between services, reduce a service search space, and improve service recommendation efficiency. For instance, the patent No. 201810424947.3 is a Web service recommendation method based on topic and service combination information. It trains a service-topic matrix with a latent dirichlet allocation (LDA) model, and predicts a user's score of a Web service with a singular value decomposition (SVD) model. Further, a Web service having a highest score is selected and recommended to a user.

All the above methods can improve accuracy and efficiency of service recommendation to a certain extent, but still have two defects as follows:
(1) Most of the above methods conduct service recommendation on the basis of user similarity and service similarity, and ignore a complementary relation between services.
(2) Most existing service recommendation methods are preliminary recommendation methods, and conduct no secondary recommendation for user input and historical recommendation results.

Complementary recommendation and secondary recommendation can better overcome the above defects in a recommendation system. Complementary recommendation generally uses a single item as input. Given candidate recommendation items mostly have different functions from input items, but both of them can be used in combination to some extent. The key of complementary recommendation lies in finding a complementary relation between items. A common technology Association Rules is used for finding the complementary relation. For instance, the patent No. 202010177173.6 is a commodity recommendation method, apparatus, device, and medium based on video analysis. In this method, an interest degree is obtained through similar association, complementary association and situational association between commodity instances in combination with commodity association rules, and a commodity instance is recommended to a potential consumer according to the interest degree. Generation of association rules mainly depends on two parameters: support and confidence. However, most of association rules generated through data mining algorithms are chaotic, which can hardly be used in recommendation work directly. Secondary recommendation can give a new recommendation result by combining user input, user feedback and historical recommendation items. Common secondary recommendation methods are mostly based on logistic regression, random forest, neural network and other technologies. Secondary recommendation has been widely used in e-commerce, social networks, short video platforms and other fields. At present, there are still less research and application of secondary recommendation in the field of service computing.

No simple and effective method exists currently, which can use association rules to mine a potential complementary relation between RESTful services and conduct secondary service recommendation.

### SUMMARY

In order to overcome defects in the prior art, to fully excavate a complementary relation between RESTful services, and to improve accuracy and efficiency of service recommendation, the present disclosure provides a secondary recommendation method based on a service complementary relation learning model for a RESTful service. The method includes: firstly, establishing a service complementary relation learning model, and setting a service complementary relation rule; on the basis, extracting an initial service complementary relation, expanding the initial service complementary relation with service function similarity information, and creating a complementary relation graph structure; secondly, conducting representation learning on the complementary relation graph structure in combination with a mask graph attention mechanism, and obtaining embedded vectors of a RESTful service and a service function; then, computing a distance between the embedded vectors, and reducing the distance between the embedded vectors having a complementary relation with a hinge loss function; and finally, finding the RESTful service having the complementary relation according to user input, and conducting secondary service recommendation.

The present disclosure uses the following technical solutions:

A secondary recommendation method based on a service complementary relation learning model for a RESTful service includes the following steps:
step 1: creating a service complementary relation learning model, establishing a RESTful service invocation data set, setting a service complementary relation rule, and extracting an initial service complementary relation as follows:
1.1. enabling the service complementary relation learning model to be a deep learning model capable of learning a service complementary relation between data samples of the RESTful service and conducting secondary recommendation on the basis of the service complementary relation, which is represented by a symbol SCRM;
1.2. enabling the RESTful service invocation data set to be a collection of data samples related to a service, a service invocation sequence and a service combination, which is represented by a symbol C;
1.3. configuring the service complementary relation rule to describe related information of strength of a complementary relation between two RESTful services in SCRM; and
1.4. extracting the initial service complementary relation as follows: extracting the initial service complementary relation in C according to the service complementary relation rule formulated in step 1.3;
step 2: expanding the initial service complementary relation extracted in step 1.4 with service function similarity information, and obtaining a function service complementary relation as follows:
2.1. using the service function similarity information as follows: determining that any two RESTful services are functionally similar if subordinate service functions of the services have the same item, where a degree of similarity is evaluated with service function similarity; and
2.2. expanding the initial service complementary relation as follows: finding functionally similar RESTful services in the RESTful service invocation data set so as to expand the initial service complementary relation, and obtaining the function service complementary relation;
step 3: creating a complementary relation graph structure on the basis of the initial service complementary relation and the function service complementary relation as follows:
3.1. configuring the complementary relation graph structure to describe a directed weighted graph of the initial service complementary relation and the function service complementary relation in SCRM, which is defined as ACWG=<V, E, W>, where ACWG represents the complementary relation graph structure, V represents a node set, E represents a directed edge set, and W represents a weight matrix; and
3.2. creating the complementary relation graph structure as follows: transforming the initial service complementary relation and the function service complementary relation into nodes, directed edges and edge weights in the complementary relation graph structure;
step 4: transforming the RESTful service into an embedded vector through representation learning, learning an attention coefficient from the complementary relation graph structure AWCG created in step 3 with a mask graph attention mechanism, and optimizing the embedded vector in combination with the attention coefficient as follows:
4.1. transforming a data sample into a low-dimensional vector representation through representation learning that is a commonly used deep learning method, and firstly transforming any RESTful service α into an embedded vector ε_{α} having a dimension d through representation learning in SCRM, where d is a hyper-parameter representing a dimension;
4.2. learning the complementary relation graph structure in combination with the mask graph attention mechanism, and obtaining the attention coefficient; and
4.3. optimizing the embedded vector with the attention coefficient as follows: conducting weighted average processing on the embedded vector with an attention coefficient between a node and a neighbor node;
step 5: computing vector distances of different RESTful services in SCRM, transforming service functions into embedded vectors, and computing vector distances of different service functions as follows:
5.1. obtaining the vector distance of the RESTful service as follows: mapping the RESTful service to a vector space through step 4, and determining a distance between different RESTful services in the vector space to be the vector distance of the RESTful service;
5.2. transforming the service function as follows: transforming the service function into the embedded vector through representation learning; and
5.3. computing the vector distance of the service function as follows: mapping the service function to the vector space through step 5.2, and determining a distance between different service functions in the vector space to be the vector distance of the service function;
step 6: optimizing SCRM with a gradient descent algorithm and a hinge loss function, and reducing a vector distance between a RESTful service and a service function having a complementary relation, where the gradient descent algorithm is an optimization algorithm in deep learning and is configured to find a local minimum of a function, and the hinge loss function is a loss function commonly used in semi-supervised learning; and
step 7: finding closest RESTful service and service function that are complementary to user input with SCRM, and implementing secondary recommendation.

Further, in step 1.2, the service invocation data set includes the following information:
1.2.1. a RESTful service: a RESTful application programming interface (API) service, which is represented by a symbol α;
1.2.2. a service invocation frequency: a total invocation frequency of a RESTful service, which is represented by a symbol Contain(α);
1.2.3. the service invocation sequence: a sequence consisting of invoked RESTful services, which is represented by a symbol c;
1.2.4. the service combination: a combination mode of RESTful services, which is represented by a symbol MA; and
1.2.5. a total service combination number: a total number of service combinations in the RESTful service invocation data set, which is represented by a symbol |MA|.

Further, in step 1.3, the service complementary relation rule includes the following information:
1.3.1. a support threshold: a lowest probability of simultaneous appearance of any two RESTful services α₁ and α₂ in c, which is represented by a symbol ω;
1.3.2. a confidence threshold: a lowest conditional probability of appearance of a RESTful service α₂ on the premise of appearance of a RESTful service α₁ in c, which is represented by a symbol δ;
1.3.3. co-occurrence: a condition that RESTful services α₁ and α₂ simultaneously appear in c, which is referred to as one time of co-occurrence, where a co-occurrence frequency is represented by a symbol Co(α₁, α₂); and
1.3.4. the initial service complementary relation that exists between two RESTful services if a result computed on the basis of the service invocation frequency, the co-occurrence frequency and the total service combination number satisfies a given support threshold and a given confidence threshold.

Further, in step 1.4, the initial service complementary relation is extracted as follows:
1.4.1. taking any two RESTful services from C, which are recorded as α₁ and α₂ respectively;
1.4.2. setting an invocation frequency Contain(α₁) of αᵢ to be 0;
1.4.3. setting a co-occurrence frequency Co(α₁, α₂) of α₁ and α₂ to be 0;
1.4.4. traversing the service invocation sequence in C in sequence, and recording the service invocation sequence taken at the i^{th} time as cᵢ;
1.4.5. adding 1 to Contain(α₁) if α₁ appears in cᵢ;
1.4.6. adding 1 to Co(α₁, α₂) if α₁ and α₂ simultaneously appear in cᵢ;
1.4.7. ending traversal when cᵢ is a last service invocation sequence in C;
1.4.8. comparing a result of dividing Co(α₁, α₂) by IMAI with ω, and skipping to step 1.4.1 if the result is smaller than ω; and
1.4.9. comparing a result of dividing Co(α₁, α₂) by Contain(α₁) with δ, and skipping to step 1.4.1 if the result is smaller than δ; and
1.4.10. outputting the initial service complementary relation between α₁ and α₂, which is recorded as (α₁, α₂)^{com}.

In step 2.1, the service function similarity information includes the following contents:
2.1.1. a service function: a subordinate function type of the RESTful service, which is represented by a symbol Category, where a service α having a function of a type i is represented by α→Categoryᵢ, and a symbol→represents a subordinate relation between the RESTful service and the service function;
2.1.2. a service function set: a collection of all subordinate service functions of the RESTful service α, which is recorded as CAT(α);
2.1.3. the service function similarity: a result of dividing a module of an intersection of a collection CAT(α₁) and a collection CAT(α₂) for the functionally similar RESTful services α₁ and α₂ by a result of a module of CAT(α₁), which is recorded as sim(α₁, α₂);
2.1.4. service complementary relation confidence configured to evaluate credibility of the service complementary relation, where for the initial service complementary relation, the confidence is 1; and for the function service complementary relation, a confidence value is sim(α₁, α_{former}), and α_{former} is an expanded service; and
2.1.5. a service complementary relation set: a collection of all initial service complementary relations and function service complementary relations, which is represented by a symbol COM.

In step 2.2, the initial service complementary relation is expanded as follows:
2.2.1. giving and adding any initial service complementary relation (α₁, α₂)^{com} to the service complementary relation set COM;
2.2.2. finding the service function set CAT(α₂) corresponding to α₂;
2.2.3. traversing the RESTful services in C in sequence, and recording the service taken at the i^{th} time as αᵢ;
2.2.4. computing function similarity sim(α₁, α₂) between α₁ and α₂, and skipping to 2.2.6 if sim(α₁, α₂) is 0;
2.2.5. expanding the initial service complementary relation (α₁, α₂)^{com} to (α₁, αᵢ)^{com}, and determining (α₁, α₁)^{com} to be the function service complementary relation;
2.2.6. assigning a value to the service complementary relation confidence of (α₁, αᵢ)^{com}, which is sim(α₁, α₂);
2.2.7. adding (α₁, α₁)^{com} to COM; and
2.2.8. ending traversal when αᵢ is a last RESTful service in C.

In step 3.1, the complementary relation graph structure includes the following information:
3.1.1. a graph node transformed from the RESTful service defined in step 1.2.1, which is represented by a symbol ν;
3.1.2. a directed edge transformed from the initial service complementary relation and the function service complementary relation, which is represented by a symbol e; and
3.1.3. an edge weight transformed from the service complementary relation confidence defined in step 2.1.4, which is represented by a symbol w.

In step 3.2, the complementary relation graph structure is created as follows:
3.2.1. traversing COM in sequence, and recording the taken initial (or function) service complementary relation as (αⱼ, αₖ)^{com};
3.2.2. creating two nodes νⱼ and νₖ to represent RESTful services α₁ and αₖ, and adding the nodes to the node set V;
3.2.3. creating a directed edge eⱼₖ from νⱼ to νₖ, and adding the directed edge to the directed edge set E;
3.2.4. evaluating an edge weight corresponding to the directed edge eⱼₖ as sim(αⱼ, αₖ), and updating a matrix value wⱼₖ in the weight matrix W; and
3.2.5. ending traversal when (αⱼ, αₖ)^{com} is a last initial (or function) service complementary relation in COM.

In step 4.2, a learning process of the mask graph attention mechanism is as follows:
4.2.1. traversing a node set of AWCG, and recording a node taken at the i^{th} time as νᵢ;
4.2.2. taking any neighbor node νⱼ of νᵢ, and skipping to step 4.2.11 if νᵢ has no neighbor node;
4.2.3. finding RESTful services corresponding to νᵢ and νⱼ, which are recorded as αᵢ and αⱼ;
4.2.4. conducting representation learning on αᵢ and αⱼ, which are transformed into d-dimensional vectors and recorded as ε_{αi} and ε_{αj} respectively;
4.2.5. defining a shared weight matrix W¹ having a size d×d′, where d′ is a hyper-parameter representing a dimension;
4.2.6. multiplying ε_{αi}, ε_{αj} and W¹, then conducting vector splicing, and recording a vector splicing result as t_{i,j};
4.2.7. defining a scalar transformation matrix W² having a size d′×1;
4.2.8. multiplying W² and t_{i,j}, and transforming the vector splicing result into a scalar k_{i,j};
4.2.9. weighting k_{i,j}, multiplying the service complementary relation confidence sim(αᵢ, αⱼ) and k_{i,j}, and recording a result as m_{i,j};
4.2.10. conducting normalization on m_{i,j} with a LeakyReLU activation function, and determining a normalization result to be an attention coefficient between nodes νᵢ and νⱼ, which is represented by a symbol α_{i,j}, where the LeakyReLU activation function is a common neural network activation function and has advantages of preventing neuron jitter, avoiding gradient disappearance and good fitting; and normalization is a commonly used mathematical method, and transforms original data and limits the data to a range of 0 to 1; and
4.2.11. ending traversal when νᵢ is a last node in AWCG.

In step 4.3, the embedded vector is optimized with the attention coefficient as follows:
4.3.1. giving an embedded vector ε_{α} of any RESTful service α, and defining and initializing an optimized vector ε′_{α} as an empty vector;
4.3.2. finding a node ν_{α} corresponding to the RESTful service α in AWCG, where a collection of all neighbor nodes of ν_{α} is represented by a symbol N_{α};
4.3.3. stopping an optimization process if N_{α} is an empty set, and outputting ε_{α} as a result;
4.3.4. traversing N_{α} in sequence, and recording a neighbor node taken at the j^{th} time as νⱼ;
4.3.5. computing an attention coefficient between the nodes ν_{α} and νⱼ according to step 4.2, where a computation result is represented by a symbol α_{α,j};
4.3.6. multiplying embedded vectors ε_{α} and α_{α,j}, and adding the result to ε′_{α}
4.3.7. ending traversal when νⱼ is a last neighbor node in N_{α}; and
4.3.8. outputting ε′_{α}.

In step 5.1, the vector distance of the RESTful service is computed as follows:
5.1.1. giving any two RESTful services αᵢ and αⱼ, and obtaining the optimized embedded vectors through step 4, which are represented by symbols ε′_{αi} and ε′_{αj} respectively;
5.1.2. defining lα_{i,j} to represent a vector distance between αᵢ and αⱼ, and initializing the vector distance to 0;
5.1.3. defining a boundary distance of a RESTful service vector, which is represented by a symbol Δα;
5.1.4. finding nodes corresponding to αᵢ and αⱼ in AWCG, which are recorded as νᵢ and νⱼ;
5.1.5. subtracting the embedded vector ε′_{αi} from the embedded vector ε′_{αj}, and conducting modulo operation on a computation result;
5.1.6. assigning a square of a module length to lα_{i,j} when νⱼ is a neighbor node of νᵢ, and skipping to step 5.1.8;
5.1.7. subtracting the square of the module length from Δα when νⱼ is not a neighbor node of νᵢ, recording a computation result as Rα, assigning Rα to lα_{i,j} when Rα is greater than 0, and skipping to step 5.1.8; and
5.1.8. outputting lα_{i,j}.

In step 5.2, the service function is transformed as follows:
5.2.1. traversing a service function set CAT(α) of a RESTful service α in sequence, and recording a service function taken at the i^{th} time as Categoryᵢ;
5.2.2. transforming the service function Categoryᵢ into a d-dimensional embedded vector through representation learning, where Categoryᵢ is recorded as qᵢ^{α} when serving as an inherent function of the service α; and Categoryᵢ is recorded as pᵢ^{α} when serving as a complementary function of the service α; and
5.2.3. ending traversal when Categoryᵢ is a last service function in CAT(α).

In step 5.3, the vector distance of the service function is computed as follows:
5.3.1. giving any two RESTful services αᵢ and αⱼ, and taking two service functions from service function sets CAT(αᵢ) and CAT(αⱼ) respectively, which are recorded as Categoryₘ and Categoryₙ;
5.3.2. transforming Categoryₘ into a vector qₘⁱ and Categoryₙ into pₙ^{j} according to step 5.2;
5.3.3. defining lc_{i,j} to represent a vector distance between Categoryₘ and Categoryₙ, and initializing the vector distance to 0;
5.3.4. defining a boundary distance of a vector, which is represented by a symbol Δc;
5.3.5. finding nodes corresponding to αᵢ and αⱼ in AWCG, which are recorded as νᵢ and νⱼ;
5.3.6. subtracting the embedded vector qₘⁱ from the embedded vector pₙ^{j}, and conducting modulo operation on a computation result;
5.3.7. assigning a square of a module length to lc_{i,j} when νⱼ is a neighbor node of νᵢ, and skipping to step 5.3.9;
5.3.8. subtracting the square of the module length from Δc when νⱼ is not a neighbor node of νᵢ, recording a computation result as Rc, assigning Rc to lc_{i,j} when Rc is greater than 0, and skipping to step 5.3.9; and
5.3.9. outputting lc_{i,j}.

In step 6, the vector distance in SCRM is reduced with a hinge function as follows:
6.1. computing vector distances between all different RESTful services through step 5.1, and adding the vector distances between all the RESTful services, where the sum of the distances is represented by a symbol L_{α};
6.2. computing vector distances between all different service functions through step 5.3, and adding the vector distances between all the service functions, where the sum of the distances is represented by a symbol L_{c};
6.3. defining a learning intensity control parameter λ of the hinge loss function;
6.4. defining the hinge loss function with an expression of =λLα+(1−λ)L_{c}, where a symbol L represents the hinge loss function; and
6.5. setting L as an optimization target, repeating 6.1 to 6.5 on a RESTful service invocation data set C, and finding a minimum value of L with the gradient descent algorithm.

Step 7 includes:
7.1. obtaining an embedded vector of α through step 4.3 for a RESTful service α input by a user, which is represented by a symbol ε_{α}^{c′};
7.2. transforming a service function of the RESTful service α through step 5.2, and taking any transformed vector, which is represented by a symbol qᵢ^{α};
7.3. defining a vector distance collection Dis_A of a service;
7.4. defining a vector distance collection Dis_C of a service function;
7.5. traversing C in sequence, and recording a RESTful service taken at the j^{th} time as αⱼ;
7.6. computing a vector distance between the service α and the service αⱼ according to step 5.1, and adding a computation result to Dis_A;
7.7. computing a vector distance between service functions of the service α and the service αⱼ according to step 5.3, and adding a computation result to Dis_C;
7.8. ending traversal when αⱼ is a last service in C;
7.9. obtaining top K₁ services having a smallest distance in Dis_A, where K₁ represents a number of recommended services, and obtained results are represented by a collection S(α, αⱼ);
7.10. obtaining top K₂ service functions having a smallest distance in Dis_C, where K₂ represents a number of recommended service functions, and obtained results are represented by a collection T(α, αⱼ); and
7.11. conducting secondary recommendation, where S(α, αⱼ) is regarded as a second recommendation result of a complementary service; and T(α, αⱼ) is regarded as a secondary recommendation result of a complementary service function.

The present disclosure has beneficial effects as follows: in the case that existing service recommendation methods mostly pay attention to an effect of a preliminary service recommendation sequence and ignore real-time feedback information of users, a secondary recommendation technology can effectively use real-time feedback information of a user, provide a dynamic recommendation result, and improve comprehensive quality of recommendation results. The secondary recommendation technology has been widely used in a recommendation system. There is a lot of research work on the secondary recommendation technology, but the work still needs to be improved. Changhua Pei, a researcher of the Chinese academy of Sciences, published a paper “Personalized re-ranking for recommendation” at proceedings of the 13^{th} ACM Conference on Recommender Systems in 2019, and proposed a PRM model. The model re-ranks recommendation results in a personalized manner with a self-attention mechanism and conducts secondary recommendation. However, the PRM model fails to grasp a complementary relation between services, and research on service representation is not deep enough. Further, in the journal IEEE Transactions on Knowledge and Data Engineering, Zhuoyi Lin of the Singapore Institute for Infocomm Research published a paper “Attention over Self-attention: Intention-aware Re-ranking with Dynamic Transformer Encoders for Recommendation”, and proposed a RAISE model. It captured potential user intention in user feedback information with an intention discovering module, and introduced a dynamic transformer encoder to encode the user intention, on the basis of which secondary recommendation is conducted. However, the RAISE model is likely to give a suboptimal service recommendation result, and ignore diversity of service recommendation results.

Inspired by the above research work, the present disclosure provides the secondary recommendation method based on a service complementary relation learning model for a RESTful service. The method can analyze the service complementary relation and the service similarity information between service items, and conduct secondary recommendation of a service complementary to the selected service and non-repetitive in function, so as to improve an overall service recommendation process. The present disclosure has the following advantages:
(1) The service complementary relation learning model is designed according to RESTful service characteristics, such that the initial service complementary relation and the function service complementary relation can be effectively extracted. (2) Different types of service complementary relations are modeled with the complementary relation graph structure, which facilitates feature extraction of a downstream neural network. (3) The embedded vector representation is optimized in combination with deep learning methods such as the representation learning and the mask graph attention mechanism, such that a service recommendation effect is improved.

### BRIEF DESCRIPTION OF THE DRAWINGS

FIG. 1 shows processes of extracting an initial service complementary relation, expanding a function service complementary relation, and creating a complementary relation graph structure.

FIG. 2 shows a RESTful service invocation data set.

FIG. 3 shows experimental results of the present disclosure on a RESTful service invocation data set.

### DESCRIPTION OF THE EMBODIMENTS

The present disclosure will be further described below in conjunction with drawings of the description and examples.

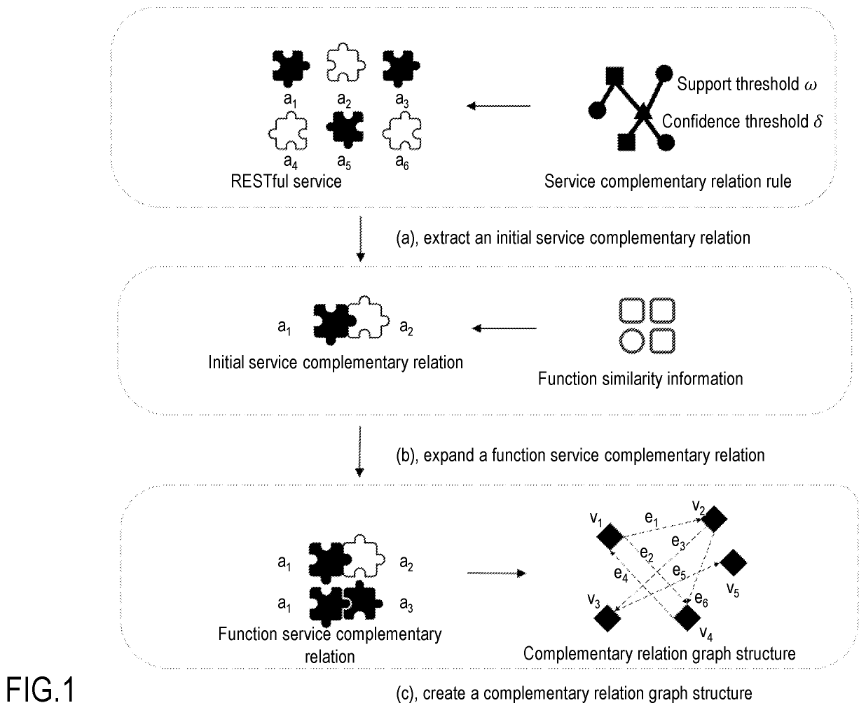

With reference to FIGS. 1-3, a secondary recommendation method based on a service complementary relation learning model for a RESTful service includes the following steps:
Step 1: a service complementary relation learning model is created, a RESTful service invocation data set is established, a service complementary relation rule is set, and an initial service complementary relation is extracted as follows:
1.1. The service complementary relation learning model is enabled to be a deep learning model capable of learning a service complementary relation between data samples of the RESTful service and conducting secondary recommendation on the basis of the service complementary relation, which is represented by a symbol SCRM.
1.2. The RESTful service invocation data set is enabled to be a collection of data samples related to a service, a service invocation sequence and a service combination, which is represented by a symbol C.

In step 1.2, the service invocation data set includes the following information:
1.2.1. a RESTful service: a RESTful application programming interface (API) service, which is represented by a symbol α;
1.2.2. a service invocation frequency: a total invocation frequency of a RESTful service, which is represented by a symbol Contain(α);
1.2.3. the service invocation sequence: a sequence consisting of invoked RESTful services, which is represented by a symbol c;
1.2.4. the service combination: a combination mode of RESTful services, which is represented by a symbol MA; and
1.2.5. a total service combination number: a total number of service combinations in the RESTful service invocation data set, which is represented by a symbol |MA|.
1.3. The service complementary relation rule is configured to describe related information of strength of a complementary relation between two RESTful services in SCRM.

In step 1.3, the service complementary relation rule includes the following information:
1.3.1. a support threshold: a lowest probability of simultaneous appearance of any two RESTful services α₁ and α₂ in c, which is represented by a symbol ω;
1.3.2. a confidence threshold: a lowest conditional probability of appearance of a RESTful service α₂ on the premise of appearance of a RESTful service α₁ in c, which is represented by a symbol δ;
1.3.3. co-occurrence: a condition that RESTful services α₁ and α₂ simultaneously appear in c, which is referred to as one time of co-occurrence, where a co-occurrence frequency is represented by a symbol Co(α₁, α₂); and
1.3.4. the initial service complementary relation that exists between two RESTful services if a result computed on the basis of the service invocation frequency, the co-occurrence frequency and the total service combination number satisfies a given support threshold and a given confidence threshold.
1.4. The initial service complementary relation is extracted as follows: the initial service complementary relation in C is extracted according to the service complementary relation rule formulated in step 1.3. A process is as shown in FIG. 1(a).

In step 1.4, the initial service complementary relation is extracted as follows:
1.4.1. any two RESTful services are taken from C, which are recorded as α₁ and α₂ respectively;
1.4.2. an invocation frequency Contain(α₁) of α₁ is set to be 0;
1.4.3. a co-occurrence frequency Co(α₁, α₂) of α₁ and α₂ is set to be 0;
1.4.4. the service invocation sequence in C is traversed in sequence, and the service invocation sequence taken at the i^{th} time is recorded as cᵢ;
1.4.5. 1 is added to Contain(α₁) if α₁ appears in cᵢ;
1.4.6. 1 is added to Co(α₁, α₂) if α₁ and α₂ simultaneously appear in cᵢ;
1.4.7. traversal is ended when cᵢ is a last service invocation sequence in C;
1.4.8. a result of dividing Co(α₁, α₂) by |MA| is compared with ω, and step 1.4.1 is skipped to if the result is smaller than ω; and
1.4.9. a result of dividing Co(α₁, α₂) by Contain(α₁) is compared with δ, and step 1.4.1 is skipped to if the result is smaller than S; and
1.4.10. the initial service complementary relation between α₁ and α₂ is output, which is recorded as (α₁, α₂)^{com}.

Step 2: the initial service complementary relation extracted in step 1.4 is expanded with service function similarity information, and a function service complementary relation is obtained as follows:
2.1. The service function similarity information is used as follows: it is determined that any two RESTful services are functionally similar if subordinate service functions of the services have the same item, where a degree of similarity is evaluated with service function similarity; and
In step 2.1, the service function similarity information includes the following contents
2.1.1. a service function: a subordinate function type of the RESTful service, which is represented by a symbol Category, where a service α having a function of a type i is represented by α→Categoryᵢ, and a symbol→represents a subordinate relation between the RESTful service and the service function;
2.1.2. a service function set: a collection of all subordinate service functions of the RESTful service α, which is recorded as CAT(α);
2.1.3. the service function similarity: a result of dividing a module of an intersection of a collection CAT(α₁) and a collection CAT(α₂) for the functionally similar RESTful services α₁ and α₂ by a result of a module of CAT(α₁), which is recorded as sim(α₁, α₂);
2.1.4. service complementary relation confidence configured to evaluate credibility of the service complementary relation, where for the initial service complementary relation, the confidence is 1; and for the function service complementary relation, a confidence value is sim(α₁, α_{former}), and α_{former} is an expanded service; and
2.1.5. a service complementary relation set: a collection of all initial service complementary relations and function service complementary relations, which is represented by a symbol COM.
2.2. The initial service complementary relation is expanded as follows: functionally similar RESTful services are found in the RESTful service invocation data set so as to expand the initial service complementary relation, and the function service complementary relation is obtained. A process is as shown in FIG. 1(b).

In step 2.2, the initial service complementary relation is expanded as follows:
2.2.1. any initial service complementary relation (α₁, α₂)^{com} is given and added to the service complementary relation set COM;
2.2.2. the service function set CAT(α₂) corresponding to α₂ is found;
2.2.3. the RESTful services in C is traversed in sequence, and the service taken at the i^{th} time is recorded as αᵢ;
2.2.4. function similarity sim(α₁, α₂) between α₁ and α₂ is computed, and 2.2.6 is skipped to if sim(αᵢ, α₂) is 0;
2.2.5. the initial service complementary relation (α₁, α₂)^{com} is expanded to (α₁, αᵢ)^{com}, and (α₁, αᵢ)^{com} is determined to be the function service complementary relation;
2.2.6. a value is assigned to the service complementary relation confidence of (α₁, αᵢ)^{com} which is sim(αᵢ, α₂);
2.2.7. (α₁, αᵢ)^{com} is added to COM; and
2.2.8. traversal is ended when αᵢ is a last RESTful service in C.

Step 3: a complementary relation graph structure is created on the basis of the initial service complementary relation and the function service complementary relation as follows:
3.1. The complementary relation graph structure is configured to describe a directed weighted graph of the initial service complementary relation and the function service complementary relation in SCRM, which is defined as ACWG=<V, E, W>. ACWG represents the complementary relation graph structure, V represents a node set, E represents a directed edge set, and W represents a weight matrix.

In step 3.1, the complementary relation graph structure includes the following information:
3.1.1. a graph node transformed from the RESTful service defined in step 1.2.1, which is represented by a symbol ν;
3.1.2. a directed edge transformed from the initial service complementary relation and the function service complementary relation, which is represented by a symbol e; and
3.1.3. an edge weight transformed from the service complementary relation confidence defined in step 2.1.4, which is represented by a symbol w.
3.2. The complementary relation graph structure is created as follows: the initial service complementary relation and the function service complementary relation are transformed into nodes, directed edges and edge weights in the complementary relation graph structure. A process is as shown in FIG. 1(c).

In step 3.2, the complementary relation graph structure is created as follows
3.2.1. COM is traversed in sequence, and the initial service complementary relation taken at the it time is recorded as (αⱼ, αₖ)^{com};
3.2.2. two nodes νⱼ and νₖ are created to represent RESTful services αⱼ and αₖ, and the nodes are added to the node set V;
3.2.3. a directed edge eⱼₖ from νⱼ to νₖ is created, and the directed edge is added to the directed edge set E;
3.2.4. an edge weight corresponding to the directed edge eⱼₖ is evaluated as sim(αⱼ, αₖ), and a matrix value wⱼₖ in the weight matrix W is updated; and
3.2.5. traversal is ended when (αⱼ, αₖ)^{com} is a last initial service complementary relation in COM.

Step 4: the RESTful service is transformed into an embedded vector through representation learning, an attention coefficient is learned from the complementary relation graph structure AWCG created in step 3 with a mask graph attention mechanism, and the embedded vector is optimized in combination with the attention coefficient as follows:
4.1. A data sample is transformed into a low-dimensional vector representation through representation learning that is a commonly used deep learning method, and the RESTful service α is transformed into an embedded vector ε_{α} through representation learning in SCRM. For instance, a bert2vec method is used.
4.2. The complementary relation graph structure is learned with the mask graph attention mechanism, and the attention coefficient is obtained.

In step 4.2, a learning process of the mask graph attention mechanism is as follows:
4.2.1. a node set of AWCG is traversed, and a node taken at the i^{th} time is recorded as νᵢ;
4.2.2. any neighbor node νⱼ of νᵢ is taken, and step 4.2.11 is skipped to if νᵢ has no neighbor node;
4.2.3. RESTful services corresponding to νᵢ and νⱼ are found, which are recorded as αᵢ and αⱼ;
4.2.4. representation learning is conducted on αᵢ and αⱼ, which are transformed into d-dimensional vectors and recorded as ε_{αi} and ε_{αj} respectively;
4.2.5. a shared weight matrix W¹ having a size d×d′ is defined, where d′ is a hyper-parameter representing a dimension;
4.2.6. ε_{αi}, ε_{αj} and W¹ are multiplied, then vector splicing is conducted, and a vector splicing result is recorded as t_{i,j};
4.2.7. a scalar transformation matrix W² having a size d′×1 is defined;
4.2.8. W² and t_{i,j} are multiplied, and the vector splicing result is transformed into a scalar k_{i,j};
4.2.9. k_{i,j} is weighted, the service complementary relation confidence sim(αᵢ, αⱼ) and k_{i,j} are multiplied, and a result is recorded as m_{i,j};
4.2.10. normalization is conducted on m_{i,j} with a LeakyReLU activation function, and a normalization result is determined to be an attention coefficient between nodes νᵢ and νⱼ, which is represented by a symbol α_{i,j}, where the LeakyReLU activation function is a common neural network activation function and has advantages of preventing neuron jitter, avoiding gradient disappearance and good fitting; and normalization is a commonly used mathematical method, and transforms original data and limits the data to a range of 0 to 1; and
4.2.11. traversal is ended when νᵢ is a last node in AWCG.

4.3. The embedded vector is optimized with the attention coefficient as follows: weighted average processing is conducted on the embedded vector with an attention coefficient between a node and a neighbor node.

In step 4.3, the embedded vector is optimized with the attention coefficient as follows:
4.3.1. an embedded vector ε_{α} of any RESTful service α is given, and an optimized vector ε′_{α} is defined and initialized as an empty vector;
4.3.2. a node ν_{α} corresponding to the RESTful service α is found in AWCG, where a collection of all neighbor nodes of ν_{α} is represented by a symbol N_{α};
4.3.3. an optimization process is stopped if N_{α} is an empty set, and ε_{α} is output as a result;
4.3.4. N_{α} is traversed in sequence, and a neighbor node taken at the j^{th} time is recorded as νⱼ;
4.3.5. an attention coefficient between the nodes ν_{α} and νⱼ is computed according to step 4.2, where a computation result is represented by a symbol α_{α,j};
4.3.6. embedded vectors ε_{α} and α_{α,j} are multiplied, and the result is added to ε′_{α}
4.3.7. traversal is ended when νⱼ is a last neighbor node in N_{α}; and
4.3.8, ε′_{α} is output.

Step 5: vector distances of different RESTful services in SCRM are computed, service functions are transformed into embedded vectors, and vector distances of different service functions are computed as follows:
5.1. The vector distance of the RESTful service is obtained as follows: the RESTful service is mapped to a vector space through step 4, and a distance between different RESTful services in the vector space is determined to be the vector distance of the RESTful service;
In step 5.1, the vector distance of the RESTful service is computed as follows:
5.1.1. any two RESTful services αᵢ and αⱼ are given, and the optimized embedded vectors are obtained through step 4, which are represented by symbols e′_{αi} and e′_{αj} respectively;
5.1.2. lα_{i,j} is defined to represent a vector distance between αᵢ and αⱼ, and the vector distance is initialized to 0;
5.1.3. a boundary distance of a RESTful service vector is defined, which is represented by a symbol Δα;
5.1.4. nodes corresponding to αᵢ and αⱼ are found in AWCG, which are recorded as νᵢ and νⱼ;
5.1.5. the embedded vector ε′_{αi} is subtracted from the embedded vector ε′_{αj}, and modulo operation is conducted on a computation result;
5.1.6. a square of a module length is assigned to lα_{i,j} when νⱼ is a neighbor node of νᵢ, and step 5.1.8 is skipped to;
5.1.7. the square of the module length is subtracted from Δα when νⱼ is not a neighbor node of νᵢ, a computation result is recorded as Rα, Rα is assigned to lα_{i,j} when Rα is greater than 0, and step 5.1.8 is skipped to; and
5.1.8. lα_{i,j} is output.

5.2. The service function is transformed as follows: the service function is transformed into the embedded vector through representation learning.

In step 5.2, the service function is transformed as follows:
5.2.1. a service function set CAT(α) of a RESTful service α is traversed in sequence, and a service function taken at the i^{th} time is recorded as Categoryᵢ;
5.2.2. the service function Categoryᵢ is transformed into a d-dimensional embedded vector through representation learning; Categoryᵢ is recorded as qᵢ^{α} when serving as an inherent function of the service α; and Categoryᵢ is recorded as pᵢ^{α} when serving as a complementary function of the service α; and
5.2.3. traversal is ended when Categoryᵢₙ is a last service function in CAT(α).
5.3. The vector distance of the service function is computed as follows: the service function is mapped to the vector space through step 5.2, and a distance between different service functions in the vector space is determined to be the vector distance of the service function;

In step 5.3, the vector distance of the service function is computed as follows:
5.3.1. any two RESTful services αᵢ and αⱼ are given, and two service functions are taken from service function sets CAT(αⱼ) and CAT(αⱼ) respectively, which are recorded as Categoryₘ and Categoryₙ;
5.3.2. Categoryₘ and Categoryₙ are transformed into vectors qₘⁱ and pₙ^{j} according to step 5.2 respectively;
5.3.3. lc_{i,j} is defined to represent a vector distance between Categoryₘ and Categoryₙ, and the vector distance is initialized to 0;
5.3.4. a boundary distance of a vector is defined, which is represented by a symbol Δc;
5.3.5. nodes corresponding to αᵢ and αⱼ are found in AWCG, which are recorded as νᵢ and νⱼ;
5.3.6. the embedded vector qₘⁱ is subtracted from the embedded vector pₙ^{j}, and modulo operation is conducted on a computation result;
5.3.7. a square of a module length is assigned to lc_{i,j} when νⱼ is a neighbor node of νᵢ, and step 5.3.9 is skipped to;
5.3.8. the square of the module length is subtracted from Δc when νⱼ is not a neighbor node of νᵢ, a computation result is recorded as Rc, Rc is assigned to lc_{i,j} when Rc is greater than 0, and step 5.3.9 is skipped to; and
5.3.9. lc_{i,j} is output.

Step 6: SCRM is optimized with a gradient descent algorithm and a hinge loss function, and a vector distance between a RESTful service and a service function having a complementary relation is reduced. The gradient descent algorithm is an optimization algorithm in deep learning and is configured to find a local minimum of a function. The hinge loss function is a loss function commonly used in semi-supervised learning. The vector distance in SCRM is reduced with a hinge function as follows:
6.1. Vector distances between all different RESTful services are computed through step 5.1, and the vector distances between all the RESTful services are added, where the sum of the distances is represented by a symbol L_{α}.
6.2. Vector distances between all different service functions are computed through step 5.3, and the vector distances between all the service functions are added, where the sum of the distances is represented by a symbol L_{c}.
6.3. A learning intensity control parameter λ of the hinge loss function is defined.
6.4. The hinge loss function is defined with an expression of L=λL_{α}+(1−λ)L_{c}. A symbol L represents the hinge loss function.
6.5. L is set as an optimization target, 6.1 to 6.5 are repeated on a RESTful service invocation data set C, and a minimum value of L is found with a stochastic gradient descent algorithm. The stochastic gradient descent algorithm is a common optimization algorithm in machine learning methods.

Step 7: closest RESTful service and service function that are complementary to user input are found with SCRM, and secondary recommendation is implemented as follows:
7.1. An embedded vector of α is obtained through step 4.3 for a RESTful service α input by a user, which is represented by a symbol ε_{α}^{c′}.
7.2. A service function of the RESTful service α is transformed through step 5.2, and any transformed vector is taken, which is represented by a symbol qᵢ^{α}.
7.3. A vector distance collection Dis_A of a service is defined.
7.4. A vector distance collection Dis_C of a service function is defined.
7.5. C is traversed in sequence, and a RESTful service taken at the j^{th} time is recorded as αⱼ.
7.6. A vector distance between the service α and the service αⱼ is computed according to step 5.1, and a computation result is added to Dis_A.
7.7. A vector distance between service functions of the service α and the service αⱼ is computed according to step 5.3, and a computation result is added to Dis_C.
7.8. Traversal is ended when αⱼ is a last service in C.
7.9. Top K₁ services having a smallest distance in Dis_A are obtained, where K₁ represents a number of recommended services, and obtained results are represented by a collection S(α,αⱼ).
7.10. Top K₂ service functions having a smallest distance in Dis_C are obtained, where K₂ represents a number of recommended service functions, and obtained results are represented by a collection T(α, αⱼ).
7.11. Secondary recommendation is conducted, where S(α, αⱼ) is regarded as a second recommendation result of a complementary service; and T(α, αⱼ) is regarded as a secondary recommendation result of a complementary service function.

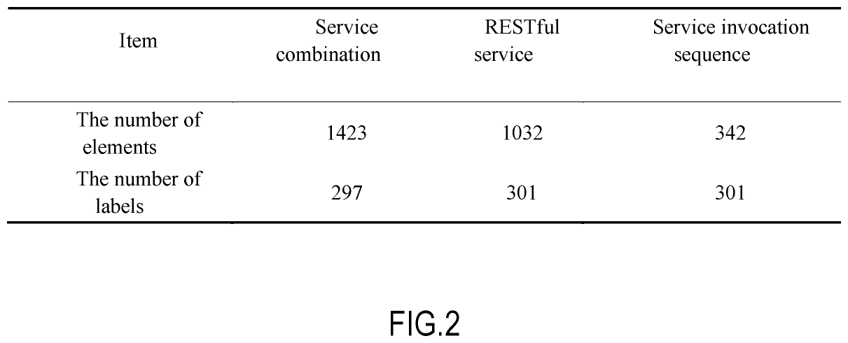

Actual effects of the present disclosure will be analyzed below with specific service data:
1. A verification environment of the example is Intel i9-12900K, NVIDIA GeForce RTX 3090, a workstation having 128 GB memory, and source codes used are achieved on the basis of Pytorch.
2. The given RESTful service invocation data set includes 1423 service combinations, 1032 RESTful services and 324 service invocation sequences, which is specifically as shown in FIG. 2. In FIG. 2, the number of elements refers to the number of RESTful services, and the number of labels refers to the number of service functions included.
3. Related experiments are conducted with the parameter selection strategy as follows: a feature dimension of the RESTful service is set to be 64; a support threshold ω and a confidence threshold δ are set to be 0.005 and 0.3 respectively; boundary distances Δα and Δc are uniformly selected as 1.0; a learning intensity control parameter λ of the hinge loss function is set to be 0.7; and the number K₁ of recommended services is set to be 6, and the number K₂ of recommended service functions is set to be 6.
4. A service recommendation method based on direct association rules (DAR) is used as a comparison method, and DAR is a traditional common service recommendation method. A second recommendation effect of the present disclosure is evaluated with a hit ratio (HR) index, and a computation rule of the HR index is as follows:

HR=|RecA∩OriA|/|OriA|

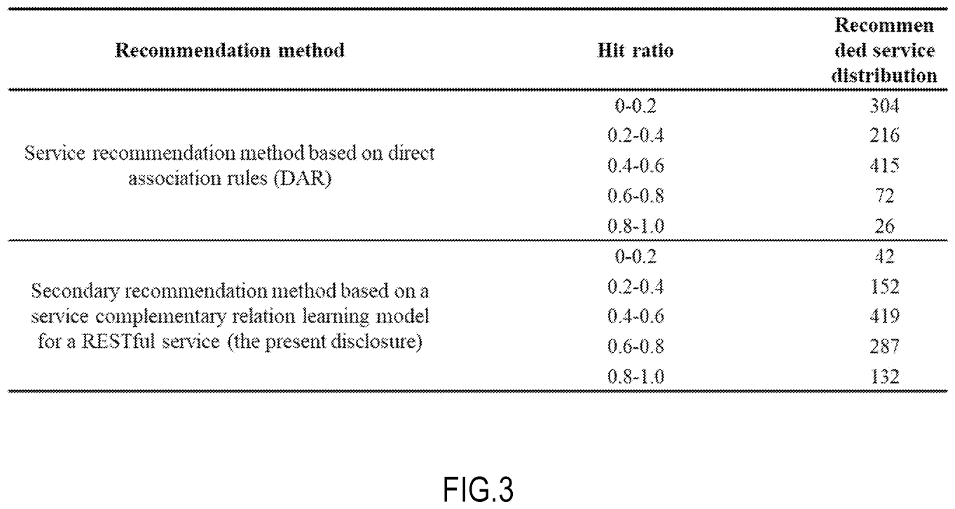

RecA represents a service recommended to a user by the recommendation method, and indicates a service recommendation result given according to the direct association rules in the DAR method. In the present disclosure, the RecA indicates a secondary recommendation result given by SCRM.OriA represents a service left after initial input of a user is removed from the RESTful service invocation data set.
5. 80% of data is randomly selected from the RESTful service invocation data set so as to train a service relation complementary model, and the remaining 20% of data is used as test samples. An experimental effect is as shown in FIG. 3.
6. Through analysis of FIG. 3, it can be seen that the present disclosure has a better recommendation effect than a traditional DAR method. Through observation of hit ratio distribution of 1032 recommended services, it can be seen that the DAR method shows a smaller hit ratio. A number of recommended services having a hit ratio smaller than 0.4 accounts for 50.38% of a total recommendation number, and a number of recommended services having a hit ratio smaller than 0.6 accounts for 90.60% of a total recommendation number Compared with the DAR method, the present disclosure has a greater hit ratio. A number of recommended services having a hit ratio greater than 0.8 accounts for 12.79% of a total recommendation number, and a number of recommended services having a hit ratio greater than 0.6 accounts for 40.60% of a total recommendation number.

What are described in the examples of the description are only instances of embodiments of the inventive concept, and are only for illustrative purposes. The protective scope of the present disclosure should not be regarded as a limitation on specific forms described in the example, and the protective scope of the present disclosure also extends to equivalent technical means that can be conceived by those of ordinary skills in the art according to the concept of the present disclosure.

What is claimed is:

1. A secondary recommendation method based on a service complementary relation learning model for a RESTful service, comprising the following steps:
step 1: creating a service complementary relation learning model, establishing a RESTful service invocation data set, setting a service complementary relation rule, and extracting an initial service complementary relation as follows:
1.1. enabling the service complementary relation learning model to be a deep learning model capable of learning a service complementary relation between data samples of the RESTful service and conducting secondary recommendation on the basis of the service complementary relation, which is represented by a symbol SCRM;
1.2. enabling the RESTful service invocation data set to be a collection of data samples related to a service, a service invocation sequence and a service combination, which is represented by a symbol C;
1.3. configuring the service complementary relation rule to describe related information of strength of a complementary relation between two RESTful services in SCRM; and
1.4. extracting the initial service complementary relation as follows: extracting the initial service complementary relation in C according to the service complementary relation rule formulated in step 1.3;
step 2: expanding the initial service complementary relation extracted in step 1.4 with service function similarity information, and obtaining a function service complementary relation as follows:
2.1. using the service function similarity information as follows: determining that any two RESTful services are functionally similar if subordinate service functions of the services have the same item, wherein a degree of similarity is evaluated with service function similarity; and
2.2. expanding the initial service complementary relation as follows: finding functionally similar RESTful services in the RESTful service invocation data set so as to expand the initial service complementary relation, and obtaining the function service complementary relation;
step 3: creating a complementary relation graph structure on the basis of the initial service complementary relation and the function service complementary relation as follows:
3.1. configuring the complementary relation graph structure to describe a directed weighted graph of the initial service complementary relation and the function service complementary relation in SCRM, which is defined as ACWG=<V, E, W>, wherein ACWG represents the complementary relation graph structure, V represents a node set, E represents a directed edge set, and W represents a weight matrix; and
3.2. creating the complementary relation graph structure as follows: transforming the initial service complementary relation and the function service complementary relation into nodes, directed edges and edge weights in the complementary relation graph structure;
step 4: transforming the RESTful service into an embedded vector through representation learning, learning an attention coefficient from the complementary relation graph structure AWCG created in step 3 with a mask graph attention mechanism, and optimizing the embedded vector in combination with the attention coefficient as follows:
4.1. transforming a data sample into a low-dimensional vector representation through representation learning, and firstly transforming any RESTful service α into an embedded vector ε_{α} having a dimension d through representation learning in SCRM, wherein d is a hyper-parameter representing a dimension;
4.2. learning the complementary relation graph structure in combination with the mask graph attention mechanism, and obtaining the attention coefficient; and
4.3. optimizing the embedded vector with the attention coefficient as follows: conducting weighted average processing on the embedded vector with an attention coefficient between a node and a neighbor node;
step 5: computing vector distances of different RESTful services in SCRM, transforming service functions into embedded vectors, and computing vector distances of different service functions as follows:
5.1. obtaining the vector distance of the RESTful service as follows: mapping the RESTful service to a vector space through step 4, and determining a distance between different RESTful services in the vector space to be the vector distance of the RESTful service;
5.2. transforming the service function as follows: transforming the service function into the embedded vector through representation learning; and
5.3. computing the vector distance of the service function as follows: mapping the service function to the vector space through step 5.2, and determining a distance between different service functions in the vector space to be the vector distance of the service function;
step 6: optimizing SCRM with a gradient descent algorithm and a hinge loss function, and reducing a vector distance between a RESTful service and a service function having a complementary relation, wherein the gradient descent algorithm is an optimization algorithm in deep learning and is configured to find a local minimum of a function, and the hinge loss function is a loss function commonly used in semi-supervised learning; and
step 7: finding closest RESTful service and service function that are complementary to user input with SCRM, and implementing secondary recommendation.

2. The secondary recommendation method based on the service complementary relation learning model for the RESTful service according to claim 1, wherein in step 1.2, the service invocation data set comprises the following information:
1.2.1. a RESTful service: a RESTful application programming interface (API) service, which is represented by a symbol α;
1.2.2. a service invocation frequency: a total invocation frequency of a RESTful service, which is represented by a symbol Contain(α);
1.2.3. the service invocation sequence: a sequence consisting of invoked RESTful services, which is represented by a symbol c;
1.2.4. the service combination: a combination mode of RESTful services, which is represented by a symbol MA; and
1.2.5. a total service combination number: a total number of service combinations in the RESTful service invocation data set, which is represented by a symbol |MA|.

3. The secondary recommendation method based on the service complementary relation learning model for the RESTful service according to claim 1, wherein in step 1.3, the service complementary relation rule comprises the following information:
1.3.1. a support threshold: a lowest probability of simultaneous appearance of any two RESTful services α₁ and α₂ in c, which is represented by a symbol ω;
1.3.2. a confidence threshold: a lowest conditional probability of appearance of a RESTful service α₂ on the premise of appearance of a RESTful service α₁ in c, which is represented by a symbol δ;
1.3.3. co-occurrence: a condition that RESTful services α₁ and α₂ simultaneously appear in c, which is referred to as one time of co-occurrence, wherein a co-occurrence frequency is represented by a symbol Co(α₁, α₂); and
1.3.4, the initial service complementary relation that exists between two RESTful services if a result computed on the basis of the service invocation frequency, the co-occurrence frequency and the total service combination number satisfies a given support threshold and a given confidence threshold.

4. The secondary recommendation method based on the service complementary relation learning model for the RESTful service according to claim 1, wherein in step 1.4, the initial service complementary relation is extracted as follows:
1.4.1. taking any two RESTful services from C, which are recorded as α₁ and α₂ respectively;
1.4.2. setting an invocation frequency Contain(α₁) of αᵢ to be 0;
1.4.3. setting a co-occurrence frequency Co(α₁, α₂) of α₁ and α₂ to be 0;
1.4.4. traversing the service invocation sequence in C in sequence, and recording the service invocation sequence taken at the it time as cᵢ;
1.4.5. adding 1 to Contain(α₁) if α₁ appears in cᵢ;
1.4.6. adding 1 to Co(α₁, α₂) if α₁ and α₂ simultaneously appear in cᵢ;
1.4.7. ending traversal when cᵢ is a last service invocation sequence in C;
1.4.8. comparing a result of dividing Co(α₁, α₂) by |MA| with ω, and skipping to step 1.4.1 if the result is smaller than ω;
1.4.9. comparing a result of dividing Co(α₁, α₂) by Contain(α₁) with δ, and skipping to step 1.4.1 if the result is smaller than S; and
1.4.10. outputting the initial service complementary relation between αᵢ and α₂, which is recorded as (α₁, α₂)^{com}.

5. The secondary recommendation method based on the service complementary relation learning model for the RESTful service according to claim 1, wherein in step 2.1, the service function similarity information comprises the following contents:
2.1.1. a service function: a subordinate function type of the RESTful service, which is represented by a symbol Category, wherein a service α having a function of a type i is represented by α→Categoryᵢ, and a symbol→represents a subordinate relation between the RESTful service and the service function;
2.1.2. a service function set: a collection of all subordinate service functions of the RESTful service α, which is recorded as CAT(α);
2.1.3. the service function similarity: a result of dividing a module of an intersection of a collection CAT(α₁) and a collection CAT(α₂) for the functionally similar RESTful services α₁ and α₂ by a result of a module of CAT(α₁), which is recorded as sim(α₁, α₂);
2.1.4. service complementary relation confidence configured to evaluate credibility of the service complementary relation, wherein for the initial service complementary relation, the confidence is 1; and for the function service complementary relation, a confidence value is sim(α₁, α_{former}), and α_{former} is an expanded service; and
2.1.5. a service complementary relation set: a collection of all initial service complementary relations and function service complementary relations, which is represented by a symbol COM; and
in step 2.2, the initial service complementary relation is expanded as follows:
2.2.1. giving and adding any initial service complementary relation (α₁, α₂)^{com} to the service complementary relation set COM;
2.2.2. finding the service function set CAT(α₂) corresponding to α₂;
2.2.3. traversing the RESTful services in C in sequence, and recording the service taken at the i^{th} time as αⱼ;
2.2.4. computing function similarity sim(αᵢ, α₂) between αᵢ and α₂, and skipping to 2.2.6 if sim(αᵢ, α₂) is 0;
2.2.5. expanding the initial service complementary relation (α₁, α₂)^{com} to (α₁, αᵢ)^{com}, and determining (α₁, αᵢ)^{com} to be the function service complementary relation;
2.2.6, assigning a value to the service complementary relation confidence of (α₁, αᵢ)^{com}, which is sim(αᵢ, α₂);
2.2.7. adding (α₁, αᵢ)^{com} to COM; and
2.2.8. ending traversal when αᵢ is a last RESTful service in C.

6. The secondary recommendation method based on the service complementary relation learning model for the RESTful service according to claim 1, wherein in step 3.1, the complementary relation graph structure comprises the following information:
3.1.1. a graph node transformed from the RESTful service defined in step 1.2.1, which is represented by a symbol ν;
3.1.2. a directed edge transformed from the initial service complementary relation and the function service complementary relation, which is represented by a symbol e; and
3.1.3. an edge weight transformed from the service complementary relation confidence defined in step 2.1.4, which is represented by a symbol w; and
in step 3.2, the complementary relation graph structure is created as follows:
3.2.1. traversing COM in sequence, and recording the taken initial or function service complementary relation as (αⱼ, αₖ)^{com};
3.2.2. creating two nodes νⱼ and νₖ to represent RESTful services αⱼ and αₖ, and adding the nodes to the node set V;
3.2.3. creating a directed edge eⱼₖ from νⱼ to νₖ, and adding the directed edge to the directed edge set E;
3.2.4. evaluating an edge weight corresponding to the directed edge eⱼₖ as sim(αⱼ, αₖ), and updating a matrix value wⱼₖ in the weight matrix W; and
3.2.5. ending traversal when (αⱼ, αₖ)^{com} is a last initial or function service complementary relation in COM.

7. The secondary recommendation method based on the service complementary relation learning model for the RESTful service according to claim 1, wherein in step 4.2, a learning process of the mask graph attention mechanism is as follows:
4.2.1. traversing a node set of AWCG, and recording a node taken at the i^{th} time as νᵢ;
4.2.2. taking any neighbor node νⱼ of νᵢ, and skipping to step 4.2.11 if νᵢ has no neighbor node;
4.2.3. finding RESTful services corresponding to νᵢ and νⱼ, which are recorded as αᵢ and αⱼ;
4.2.4. conducting representation learning on αᵢ and αⱼ, which are transformed into d-dimensional vectors and recorded as ε_{αi} and ε_{αj} respectively;
4.2.5. defining a shared weight matrix W¹ having a size d×d′, wherein d′ is a hyper-parameter representing a dimension;
4.2.6. multiplying ε_{αi}, ε_{αj} and W¹, then conducting vector splicing, and recording a vector splicing result as t_{i,j};
4.2.7. defining a scalar transformation matrix W² having a size d′×1;
4.2.8. multiplying W² and t_{i,j}, and transforming the vector splicing result into a scalar k_{i,j};
4.2.9. weighting k_{i,j}, multiplying the service complementary relation confidence sim(αᵢ, αⱼ) and k_{i,j}, and recording a result as m_{i,j};
4.2.10. conducting normalization on m_{i,j} with a LeakyReLU activation function, and determining a normalization result to be an attention coefficient between nodes νᵢ and νⱼ, which is represented by a symbol α_{i,j}, wherein the LeakyReLU activation function is a common neural network activation function and has advantages of preventing neuron jitter, avoiding gradient disappearance and good fitting; and normalization is a commonly used mathematical method, and transforms original data and limits the data to a range of 0 to 1; and
4.2.11. ending traversal when νᵢ is a last node in AWCG; and
in step 4.3, the embedded vector is optimized with the attention coefficient as follows:
4.3.1. giving an embedded vector ε_{α} of any RESTful service α, and defining and initializing an optimized vector ε′_{α} as an empty vector;
4.3.2. finding a node ν_{α} corresponding to the RESTful service α in AWCG, wherein a collection of all neighbor nodes of ν_{α} is represented by a symbol N_{α};
4.3.3. stopping an optimization process if N_{α} is an empty set, and outputting ε_{α} as a result;
4.3.4. traversing N_{α} in sequence, and recording a neighbor node taken at the j^{th} time as νⱼ;
4.3.5. computing an attention coefficient between the nodes ν_{α} and νⱼ according to step 4.2, wherein a computation result is represented by a symbol α_{α,j};
4.3.6. multiplying embedded vectors ε_{α} and α_{α,j}, and adding the result to ε′_{α};
4.3.7. ending traversal when νⱼ is a last neighbor node in N_{α}; and
4.3.8. outputting ε′_{α}.

8. The secondary recommendation method based on the service complementary relation learning model for the RESTful service according to claim 1, wherein in step 5.1, the vector distance of the RESTful service is computed as follows:
5.1.1. giving any two RESTful services αᵢ and αⱼ, and obtaining the optimized embedded vectors through step 4, which are represented by symbols ε′_{αi} and ε′_{αj} respectively;
5.1.2. defining lα_{i,j} to represent a vector distance between αᵢ and αⱼ, and initializing the vector distance to 0;
5.1.3. defining a boundary distance of a RESTful service vector, which is represented by a symbol Δα;
5.1.4. finding nodes corresponding to αᵢ and αⱼ in AWCG, which are recorded as νᵢ and νⱼ;
5.1.5. subtracting the embedded vector ε′_{αi} from the embedded vector ε′_{αj}, and conducting modulo operation on a computation result;
5.1.6. assigning a square of a module length to lα_{i,j} when νⱼ is a neighbor node of νᵢ, and skipping to step 5.1.8;
5.1.7. subtracting the square of the module length from Δα when νⱼ is not a neighbor node of νᵢ, recording a computation result as Rα, assigning Rα to lα_{i,j} when Rα is greater than 0, and skipping to step 5.1.8; and
5.1.8. outputting lα_{i,j};
in step 5.2, the service function is transformed as follows:
5.2.1. traversing a service function set CAT(α) of a RESTful service α in sequence, and recording a service function taken at the i^{th} time as Categoryᵢ;
5.2.2. transforming the service function Categoryᵢ into a d-dimensional embedded vector through representation learning, wherein Categoryᵢ is recorded as qᵢ^{α} when serving as an inherent function of the service α; and Categoryᵢ is recorded as pa when serving as a complementary function of the service α; and
5.2.3. ending traversal when Categoryᵢ is a last service function in CAT(α); and
in step 5.3, the vector distance of the service function is computed as follows:
5.3.1. giving any two RESTful services αᵢ and αⱼ, and taking two service functions from service function sets CAT(αⱼ) and CAT(αⱼ) respectively, which are recorded as Categoryₘ and Categoryₙ;
5.3.2. transforming Categoryₘ into a vector qₘⁱ and Categoryₙ into pₙ^{j} according to step 5.2;
5.3.3. defining lc_{i,j} to represent a vector distance between Categoryₘ and Categoryₙ, and initializing the vector distance to 0;
5.3.4. defining a boundary distance of a vector, which is represented by a symbol Δc;
5.3.5. finding nodes corresponding to αᵢ and αⱼ in AWCG, which are recorded as νᵢ and νⱼ;
5.3.6. subtracting the embedded vector qₘⁱ from the embedded vector pₙ^{j}, and conducting modulo operation on a computation result;
5.3.7. assigning a square of a module length to lc_{i,j} when νⱼ is a neighbor node of νᵢ, and skipping to step 5.3.9;
5.3.8. subtracting the square of the module length from Δc when νⱼ is not a neighbor node of νᵢ, recording a computation result as Rc, assigning Rc to lc_{i,j} when Rc is greater than 0, and skipping to step 5.3.9; and
5.3.9. outputting lc_{i,j}.

9. The secondary recommendation method based on the service complementary relation learning model for the RESTful service according to claim 1, wherein in step 6, the vector distance in SCRM is reduced with a hinge function as follows:
6.1. computing vector distances between all different RESTful services through step 5.1, and adding the vector distances between all the RESTful services, wherein the sum of the distances is represented by a symbol L_{α};
6.2. computing vector distances between all different service functions through step 5.3, and adding the vector distances between all the service functions, wherein the sum of the distances is represented by a symbol L_{c};
6.3. defining a learning intensity control parameter λ of the hinge loss function;
6.4. defining the hinge loss function with an expression of L=λL_{α}+(1−λ)L_{c}, wherein a symbol L represents the hinge loss function; and
6.5. setting as an optimization target, repeating 6.1 to 6.5 on a RESTful service invocation data set C, and finding a minimum value of L with the gradient descent algorithm.

10. The secondary recommendation method based on the service complementary relation learning model for the RESTful service according to claim 1, wherein step 7 comprises:
7.1. obtaining an embedded vector of α through step 4.3 for a RESTful service α input by a user, which is represented by a symbol ε_{α}^{c′};
7.2. transforming a service function of the RESTful service α through step 5.2, and taking any transformed vector, which is represented by a symbol qᵢ^{α};
7.3. defining a vector distance collection Dis_A of a service;
7.4. defining a vector distance collection Dis_C of a service function;
7.5. traversing C in sequence, and recording a RESTful service taken at a j^{th} time as αⱼ;
7.6. computing a vector distance between service α and service αⱼ according to step 5.1, and adding a computation result to Dis_A;
7.7. computing a vector distance between service functions of the service α and the service αⱼ according to step 5.3, and adding a computation result to Dis_C;
7.8. ending traversal when αⱼ is a last service in C;
7.9. obtaining top K₁ services having a smallest distance in Dis_A, wherein K₁ represents a number of recommended services, and obtained results are represented by a collection S(α, αⱼ);
7.10. obtaining top K₂ service functions having a smallest distance in Dis_C, wherein K₂ represents a number of recommended service functions, and obtained results are represented by a collection T(α, αⱼ); and
7.11. conducting secondary recommendation, wherein S(α, αⱼ) is regarded as a second recommendation result of a complementary service; and T(α, αⱼ) is regarded as a secondary recommendation result of a complementary service function.
